(19) United States
(12) Patent Application Publication
(10) Pub. No.: US 2017/0344589 A1
(43) Pub. Date: Nov. 30, 2017

(54) OUTPUT VECTOR GENERATION FROM FEATURE VECTORS REPRESENTING DATA OBJECTS OF A PHYSICAL SYSTEM

(71) Applicant: Hewlett Packard Enterprise Development LP, Houston, TX (US)

(72) Inventors: Mehran Kafai, Redwood City, CA (US); Kave Eshghi, Los Altos, CA (US)

(21) Appl. No.: 15/166,026

(22) Filed: May 26, 2016

(51) Int. Cl. G06F 17/30

(52) U.S. Cl. CPC G06F 17/30324; G06F 17/30333

(57) ABSTRACT

A system may include an access engine and a projection engine. The access engine may access a feature vector with an initial dimensionality that represents a data object of a physical system. The projection engine may generate an extended vector with an extended dimensionality from the feature vector. The projection engine may also apply an orthogonal transformation to the extended vector to obtain an intermediate vector with the extended dimensionality, as well as compute the inner products of the intermediate vector and sparse binary vectors of a sparse binary vector set. In doing so, the projection engine may obtain a randomly projected vector with an output dimensionality that is greater than the extended dimensionality of the intermediate vector. Then, the projection engine may output the randomly projected vector as an output vector that is a random projection of the feature vector with the output dimensionality.

### BACKGROUND

With rapid advances in technology, computing systems are increasingly prevalent in society today. Vast computing systems execute and support applications that communicate and process immense amounts of data, many times with performance constraints to meet the increasing demands of users. Increasing the efficiency, speed, and effectiveness of computing systems will further improve user experience.

### BRIEF DESCRIPTION OF THE DRAWINGS

Certain examples are described in the following detailed description and in reference to the drawings.

FIG. 1 shows an example of a system that supports generation of output vectors from feature vectors representing data objects of a physical system.

FIG. 2 shows an example of an architecture that supports generation of output vectors from feature vectors representing data objects of a physical system.

FIG. 3 shows an example of output vector generation by a projection engine.

FIG. 4 shows an example of output vector generation by a projection engine using a sparse binary vector set.

FIG. 5 shows a flow chart of an example method for generation of output vectors from feature vectors representing data objects of a physical system.

FIG. 6 shows an example of a system that supports generation of output vectors from feature vectors representing data objects of a physical system.

### DETAILED DESCRIPTION

The discussion below refers to feature vectors. A feature vector may refer to any vector or set of values in feature space that represents an object. Feature vectors may represent data objects in a physical system, and used across any number applications. For example, a set of feature vectors may specify characteristics data for video streaming data, digital images, internet or network traffic, organization or corporation data, gene sequences, human facial features, speech data, and countless other types of data. Feature vectors may be used to support machine-learning, classification, statistical analysis, and various other applications.

Various processing applications may use feature vectors, and such applications may transform or manipulate the feature vectors in different ways for analysis, machine-learning, classifier training, or other specific uses. Various applications may perform computations of random projections from a set of feature vectors. A random projection may refer to a randomization computation applied to a vector, for example through multiplying a vector by a matrix of random numbers drawn from a given distribution, such as uniform distribution, Bernoulli distribution, normal distribution, etc. Such random projection computations may include application of orthogonal transformations, and orthogonal transformations may increase in computational expense as the dimensionality of the feature vectors increase. The dimensionality of a vector may specify a number of dimensions that a vector has. In that regard, a particular vector may have a number of vector elements (or, phrased another way, a vector length) equal to the dimensionality of the vector.

Examples consistent with the present disclosure may support random projection computations from feature vectors without applying orthogonal transformations at a desired dimensionality of the random projection. Instead, the features described herein may include applying the orthogonal transformation at a dimensionality lesser than an output dimensionality of the random projection. Application of the orthogonal transformation at lower vector dimensionalities may ease computation expenses and reduce the time, complexity, or resource consumption required to process a feature vector. Such efficiency improvements and computation reductions may be particularly useful when generating random projections of large dimensionalities (e.g., 32,768-dimensions, 65,536-dimensions, or more) or when the feature vector set includes a large number of feature vectors to process (e.g., in the tens of millions or more). The features described herein provide for generation of output vectors that are random projections of feature vectors, and may do so with increased efficiency.

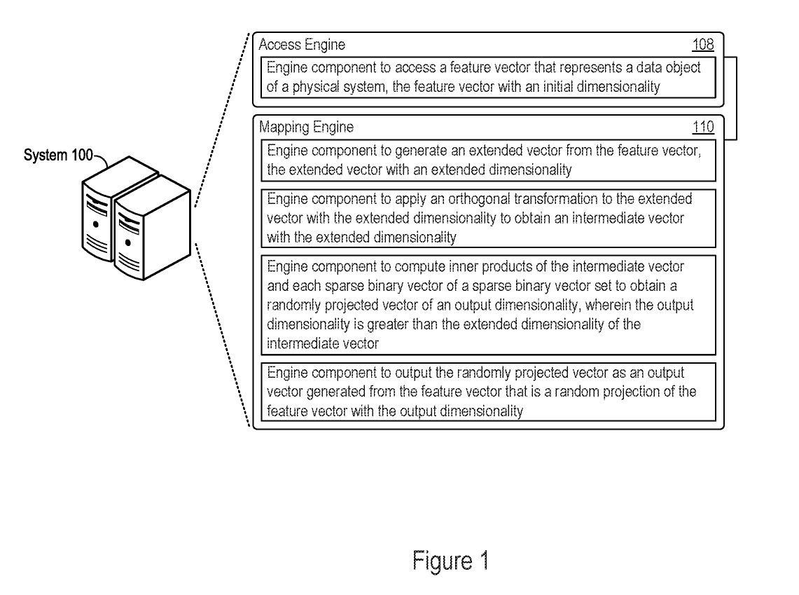

FIG. 1 shows an example of a system 100 that supports generation of output vectors from feature vectors representing data objects of a physical system. The system 100 may take the form of any computing system that includes a single or multiple computing devices such as servers, compute nodes, desktop or laptop computers, smart phones or other mobile devices, tablet devices, embedded controllers, and more.

The system 100 may generate output vectors with a specified output dimensionality that are random projections of feature vectors with an initial dimensionality. In some examples, the system 100 may generate the random projections as part of a hash value generation process, for example as part of a concomitant rank order (CRO) hash computation. In generating the random projections, the system 100 may apply an orthorgonal transformation. However, the greater the size of the hash universe (e.g., the greater the dimensionality of the random projections), the greater the computational cost of applying the orthogonal transformation in the hash universe. As an illustrative example, computing the CRO hash values in a hash universe of size 32,768 (i.e., of dimensionality 2¹⁵) may include applying an orthogonal transformation on vectors with a dimensionality of 32,768 as well. Such a computational cost may be increasingly expensive for large feature vector sets, e.g., numbering in the millions, tens of millions, or more.

As described in greater detail herein, the system 100 may provide various output vector generation features that may support generation of random projections with an output dimensionality (e.g., 32,768-dimension), but do so through application of orthogonal transformations at a smaller dimensionality (e.g., 4096-dimensions). In that regard, the output vector generation features disclosed herein may increase the efficiency of random projection computations, and may do so with similar accuracy to more computationally costly implementations. Put another way, the system 100 may generate random projections in large hash universes without actually performing an orthogonal transformation in the large hash universe. Instead, the system 100 may perform the orthogonal transformation in a smaller hash universe, which may increase the efficiency and reduce the time-complexity of processes or applications utilizing the random projection computations.

The system 100 may implement various engines to provide or support any of the output vector generation features described herein. In the example shown in FIG. 1, the system 100 implements an access engine 108 and a projection engine 110. The system 100 may implement the engines 108 and 110 (including components thereof) in various ways, for example as hardware and programming. The programming for the engines 108 and 110 may take the form of processor-executable instructions stored on a non-transitory machine-readable storage medium, and the processor-executable instructions may, upon execution, cause hardware to perform any of the features described herein. In that regard, various programming instructions of the engines 108 and 110 may implement engine components to support or provide the features described herein.

The hardware for the engines 108 and 110 may include a processing resource to execute programming instructions. A processing resource may include various number of processors with single or multiple cores, and a processing resource may be implemented through a single-processor or multi-processor architecture. In some examples, the system 100 implements multiple engines using the same system features or hardware components (e.g., a common processing resource).

The access engine 108 and the projection engine 110 may include components to support the generation of output vectors from feature vectors representing data objects of a physical system. In the example implementation shown in FIG. 1, the access engine 108 includes an engine component to access a feature vector that represents a data object of a physical system, the feature vector with an initial dimensionality. As also shown in the example implementation in FIG. 1, the projection engine 110 may include engine components to generate an extended vector from the feature vector, the extended vector with an extended dimensionality; apply an orthogonal transformation to the extended vector with the extended dimensionality to obtain an intermediate vector with the extended dimensionality; compute the inner products of the intermediate vector and each sparse binary vector of a sparse binary vector set to obtain a randomly projected vector with an output dimensionality, wherein the output dimensionality is greater than the extended dimensionality of the intermediate vector; and output the randomly projected vector as an output vector generated from the feature vector that is a random projection of the feature vector with the output dimensionality.

These and other aspects of the output vector generation features disclosed herein are discussed in greater detail next.

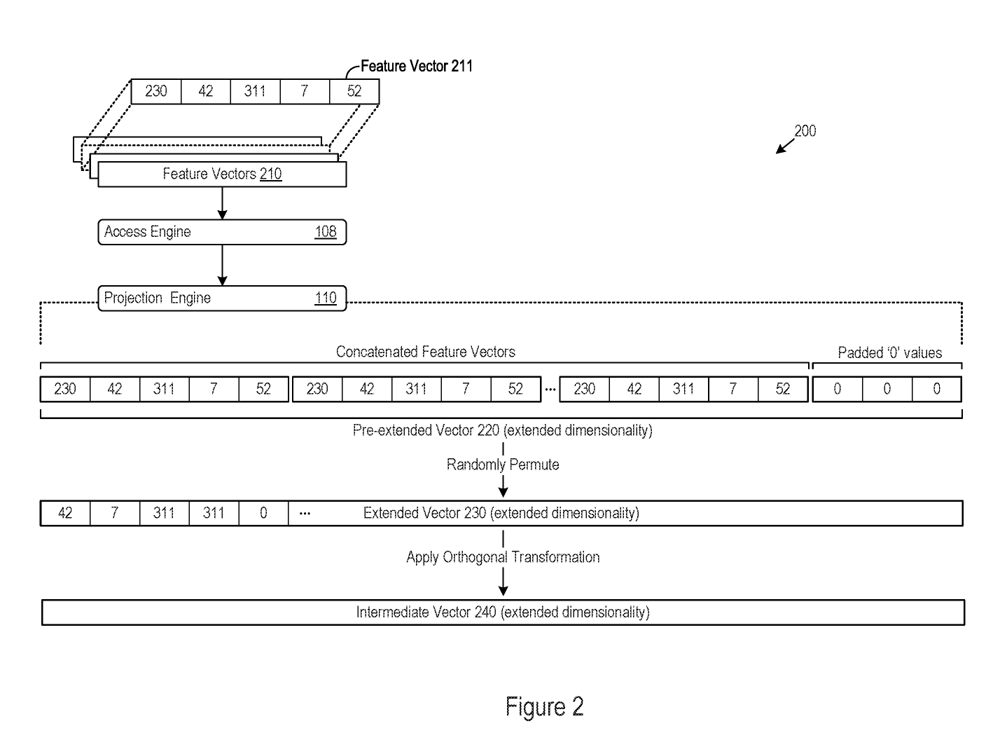

FIG. 2 shows an example of an architecture 200 that supports generation of output vectors from feature vectors representing data objects of a physical system. The architecture 200 in FIG. 2 includes the access engine 108 and the projection engine 110. The access engine 108 may receive a set of feature vectors 210 for processing and use in various functions, e.g., for machine learning tasks, classifier training, or various other applications. The feature vectors 210 may characterize or otherwise represent data objects of a physical system. Example physical systems include video streaming and analysis systems, banking systems, document repositories and analysis systems, geo-positional determination systems, enterprise communication networks, medical facilities storing medical records and biological statistics, and countless other systems that store, analyze, or process data. In some examples, the access engine 108 receives the feature vectors 210 as a real-time data stream for processing, analysis, classification, model training, or various other operations.

The feature vectors 210 may be real-valued vectors of an initial dimensionality. One example of a feature vector is shown in FIG. 2 as the feature vector 211, which has an initial dimensionality of 5 and vector values of 230, 42, 311, 7, and 52 for the 5 respective dimensions of the feature vector 211. For each of the feature vectors 210 accessed by the access engine 108, the projection engine 110 may generate an output vector with an output dimensionality that is a random projection of the feature vector. The output dimensionality may be user-specified and may be greater than the initial dimensionality characterizing the feature vectors 210. As an illustrative example used herein, the output dimensionality may be user-configured to 32,768. In this illustrative example, the projection engine 110 may generate output vectors with 32,768 dimensions that are random projections of the feature vectors of an initial dimensionality. The projection engine 110 may do without applying orthogonal transformations to vectors of 32,768 dimensions, but instead apply orthogonal transformations to vectors of a smaller dimensionality than the output dimensionality.

The dimensionality at which the projection engine 110 may apply orthogonal transformations may be referred to as an extended dimensionality. The extended dimensionality may be user-configured, and may be orders of magnitude less than the output dimensionality. For output dimensionalities that are powers of 2 (e.g., 32,678, which is 2¹⁵), the extended dimensionality may be multiple powers of 2 (e.g., multiple orders of magnitude in base 2) less than the output dimensionality. Thus, for the illustrative example with an output dimensionality of 32,678, the extended dimensionality may have a value of 4,096 (which is 2¹²) or 2048 (which is 2¹¹), as just two examples that are orders of magnitude less than the output dimensionality.

Example processes by which the projection engine 110 may generate output vectors as random computations with an output dimensionality are described next. To compute a random projection with an output dimensionality for a feature vector, the projection engine 110 may extend a feature vector to a vector size equal to the extended dimensionality. In some examples, the projection engine 110 may concatenate the feature vector together a calculated number of times and pad the concatenated feature vectors with a calculated number of vector elements having a ‘0’ value to obtain a pre-extended vector with the extended dimensionality.

To provide an illustration through the feature vector 211 shown in FIG. 2, the projection engine 110 may extend the feature vector 211 with an initial dimensionality of 5 to an extended dimensionality of 2048. In doing so, the projection engine 110 may concatenate the feature vector 211 a number of times determined through an integer division with the extended dimensionality by the initial dimensionality. In this illustrative example, the projection engine 110 may concatenate the feature vector 211 together 409 times (which is 2048 divided by 5, rounded down to the nearest integer of 409). Doing so results in a concatenated vector with a vector size of 2045, and the projection engine 110 may thus pad an additional 3 vector elements to reach the extended dimensionality of 2048. In the example shown in FIG. 2, the padded vector elements have a ‘0’ value, though any other configurable or random vector value may be set for the padded vector elements by the projection engine 110. In some instances, the projection engine 110 need not pad the feature vector concatenation with any additional vector elements, particularly when the feature vector concatenation is of a vector length exactly equal to the extended dimensionality.

The feature vector concatenation padded with additional vector elements may be referred to as a pre-extended vector 220. By generating the pre-extended vector 220 to a vector size with the extended dimensionality (and less than the output dimensionality), the projection engine 110 may control and reduce the dimensionality at which orthogonal transformations are applied in the random projection computation process. Variances in the specific value with the extended dimensionality may be adapted according to user-specification or particular performance and precision requirements. The greater the value with the extended dimensionality, the greater the precision or accuracy at which the pre-extended vector and random projection computations may represent data of the physical system. The lesser the value with the extended dimensionality, the greater the performance benefits as orthogonal transformations are performed on vectors of lesser dimensionality. As such, the specific value with the extended dimensionality may be adapted and configured according to specific performance requirements.

The projection engine 110 may randomly permute the pre-extended vector 220 to obtain an extended vector 230 with the extended dimensionality and apply an orthogonal transformation to the extended vector 230. That is, in computing the random projection for a feature vector, the projection engine 110 may apply an orthogonal transformation to a vector with an extended dimensionality (e.g., 2048 or 4096) instead of a vector with an output dimensionality (e.g., 32,768). Example orthogonal transformations the projection engine 110 may apply include discrete cosine transformations (DCTs), Walsh-Hadamard transformations, and more.

By applying the orthogonal transformation to the extended vector 230, the projection engine 110 may obtain an intermediate vector 240 with the extended dimensionality. From the intermediate vector 240 of a feature vector, the projection engine 110 may generate an output vector with the output dimensionality that is a random projection of the feature vector. The projection engine 110 may generate an intermediate vector 240 for each of the feature vectors 210, and each respective intermediate vector 240 may have a vector size with the extended dimensionality but differ in vector element values according to the specific values of each feature vector in a feature vector set. Examples of output vector generation from intermediate vectors are described next.

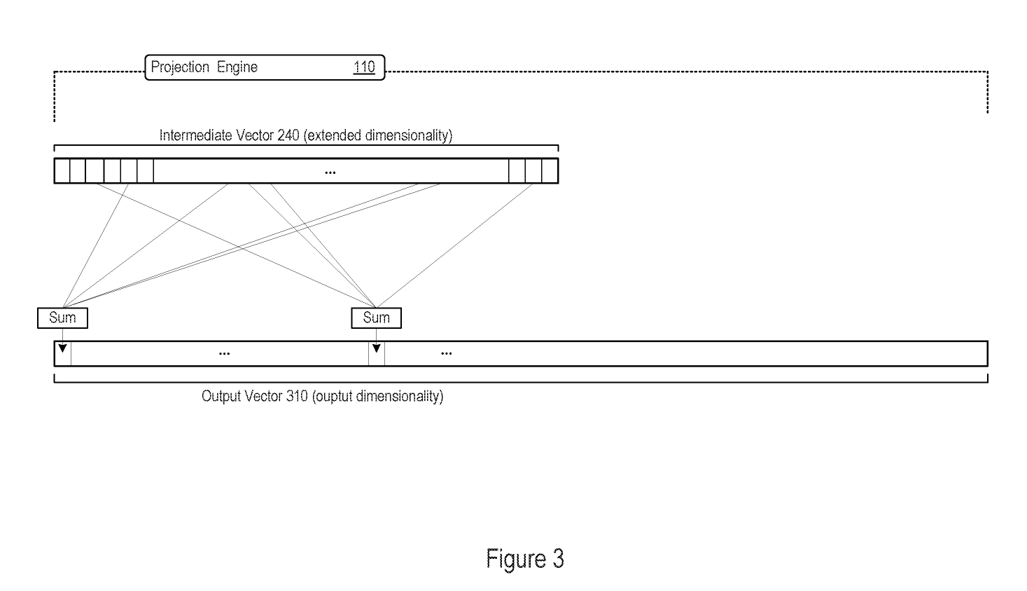

FIG. 3 shows an example of output vector generation by the projection engine 110. The projection engine 110 may generate an output vector with an output dimensionality from the intermediate vector 240 with an extended dimensionality.

In some examples, the projection engine 110 does so by computing a number of vector element values from the intermediate vector 240 equal to the output dimensionality. For an output dimensionality set to 32,768-dimensions, for example, the projection engine 110 may generate 32,768 vector element values, each of which represent a dimension value for a generated output vector. Moreover, the projection engine 110 may generate the output vector such that vector element values together form a random projection of the particular feature vector from which the output vector is generated. In FIG. 3, the projection engine 110 generates the output vector 310 with the output dimensionality from the intermediate vector 240 with the extended dimensionality, and the intermediate vector 240 may be generated from a particular feature vector with an initial dimensionality.

The projection engine 110 may compute a vector element value for the output vector 310 as a sum of selected vector elements from the intermediate vector 240. The selection of vector elements from the intermediate vector 240 may be determined according to a probability distribution, such as a uniform distribution. For example, the particular vector elements of the intermediate vector 240 selected to determine the vector elements of the output vector 310 may be selected according to a predetermined probability distribution. The number of vector elements selected from the intermediate vector 240 for each vector element of the output vector may be preset as well, e.g., to a value of 4 or any other configurable value. In this illustrative example, the projection engine 110 may select a first set of 4 particular vector elements of the intermediate vector 240 for generating the value of a first vector element of the output vector 310, a second set of 4 particular vector elements of the intermediate vector 240 for generating the value of a second vector element of the output vector 310, and so on. The selected vector elements of the intermediate vector 240 may be determined through the probability distribution selecting vector index values of the intermediate vector 240 ranging from 1-up to the value of the extended dimensionality according to the predetermined probability distribution.

Thus, for a first vector element of the output vector 310, the projection engine 110 may select a preset number of vector elements from the intermediate vector 240 according to a predetermined probability distribution. To determine the vector element value of the output vector 310 based on the selected vector elements, the projection engine 110 may sum the vector element values of the selected vector elements. The projection engine 110 may repeat such selection and summation a number of times to obtain a number of vector elements equal to the output dimensionality.

The preset number of vectors that the projection engine 110 selects from the intermediate vector 240 may be user-configurable, for example through a user interface. The lesser the preset number, the less computationally-expensive the process by which the projection engine 110 generates the output vector 310. The greater the preset number, the greater the randomization of the vector element values of the output vector 310. Configuration of the preset number of selected vector elements may be adapted according to user selection, performance requirements, or various other criteria.

In the example shown FIG. 3, the projection engine 110 configures the preset number to a value of 4. As such, the projection engine 110 may select and sum 4 different vector elements of the intermediate vector 240 to compute each of the vector elements of the output vector 310. The projection engine 110 may perform such a process for each of the intermediate vectors generated from a set of feature vectors, and thus generate a set of output vectors with an output dimensionality that are random projections of the feature vectors. Thus, the projection engine 110 may generate output vectors with the output dimensionality from intermediate vectors with the extended dimensionality, which were generated from feature vectors of the initial dimensionality.

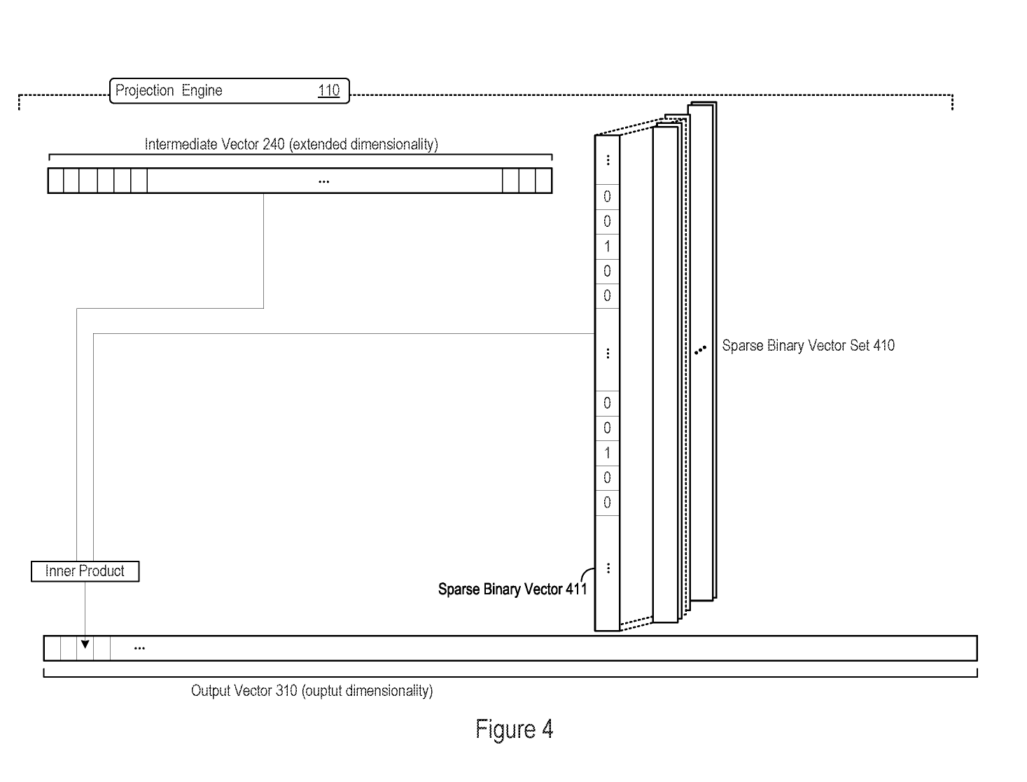

In generating multiple output vectors from multiple feature vectors, the projection engine 110 may consistently select vector elements from the intermediate vector 240 according to the predetermined probability distribution. That is, the projection engine 110 may use the same predetermined probability distribution in selecting vector elements for each of the intermediate vectors generated from respective feature vectors of a feature vector set. Put another way, for a particular vector element of each of the generated output vectors (e.g., the first vector element of each generated output vector), the projection engine 110 may sum the same selected vector elements of the intermediate vector 240 (e.g., the vector elements with vector indices 23, 63, 344, and 2035 as an illustrative example). One such way the projection engine 110 may ensure consistency in the selection of vector elements in the intermediate vector 240 is through a sparse binary vector set, for example as described next in FIG. 4.

FIG. 4 shows an example of output vector generation by the projection engine 110 using a sparse binary vector set. A sparse binary vector set may refer to a set of sparse binary vectors (SBVs), each of which may be binary (by including only ‘1’ and ‘0’ values) and sparse (by having a number of ‘1’ values significantly less than the vector dimensionality, e.g., less than a predetermined sparsity threshold or percentage). The projection engine 110 may utilize the sparse binary vectors as a selection mechanism for vector elements of intermediate vectors generated by the projection engine 110.

The projection engine 110 may generate or otherwise access a sparse binary vector set, such as the sparse binary vector set 410 shown in FIG. 4. The sparse binary vector set may include a number of sparse binary vectors equal to the output dimensionality, as each of the sparse binary vectors may be used to compute a vector element of an output vector 310 thus resulting in a number of vector elements in the output vector 310 equal to the output dimensionality.

The projection engine 110 may generate the sparse binary vectors of the sparse binary vector set 410 with a dimensionality equal to the extended dimensionality, the same vector size as the intermediate vector 240. The projection engine 110 may also generate the sparse binary vectors by setting which vector elements of each sparse binary vector as having a ‘1’ value. For each of the generated sparse binary vectors, the projection engine 110 may determine a preset number of vector elements with the ‘1’ value, and the preset number may be equal to the preset number of selected vector elements from an intermediate vector 240. Accordingly, the vector index of each ‘1’ value a sparse binary vector may indicate which elements of intermediate vector 240 are selected for a particular vector element of the output vector 310, and the projection engine 110 may generate the sparse binary vector set 410 by determining the vector elements having a ‘1’ value in the sparse binary vectors according to a predetermined probability distribution.

The projection engine 110 may utilize the sparse binary vector set 410 by computing an inner product of an intermediate vector 240 and each of the sparse binary vectors of the sparse binary vector set 410. Doing so may yield a number of computed scalar values equal to the output dimensionality that together form the output vector 310 generated for a particular feature vector. One example is shown in FIG. 4 through the sparse binary vector 411. The vector indices of the sparse binary vector 411 having a ‘1’ value may effectively indicate which vector elements of the intermediate vector 240 are selected for computing a vector element of the output vector. As the particular vector elements of the sparse binary vector 411 having a ‘1’ value may be set according to a predetermined probability distribution, in that regard the selection of the vector elements in the intermediate vector 240 may be done so according to the predetermined probability distribution as well.

The projection engine 110 may compute the inner product of the intermediate vector 240 and the sparse binary vector 411 to generate a particular vector element of the output vector 310. By computing the inner product of the intermediate vector 240 and a first sparse binary vector of the sparse binary vector set 410, the projection engine 110 may determine a first vector element value of the output vector 310. Computation of the inner product of the intermediate vector 240 and a second sparse binary vector of the sparse binary vector set 410 may result in the second vector element value of the output vector 310. The projection engine 110 may continue so on until a number of vector element values equal to the output dimensionality are computed, thus generating the output vector 310.

Accordingly, the projection engine 110 may use the sparse binary vector set 410 to calculate an output vector 310 from an intermediate vector 240 of a particular feature vector. The projection engine 110 may use the same sparse binary vector set 410 in computing the output vectors from each of the other intermediate vectors generated from the respective feature vectors of a feature vector set, thus ensuring a consistent distribution of vector elements selected from intermediate vectors according to the predetermined probability distribution to generate the output vectors.

In some examples, the projection engine 110 may represent the sparse binary vector set 410 as a matrix with a number of rows equal to the preset number of vector elements having a ‘1’ value for each sparse binary vector and a number of columns equal to the output dimensionality. A particular matrix column in the matrix may represent a particular sparse binary vector and each matrix value of the particular matrix column may represent an index of a vector element in the particular sparse binary vector that has a ‘1’ value. The matrix (which may also be referred to as a SBV matrix) may be an efficient way to represent the sparse binary vector set 410 and used by the projection engine 110 in computing the inner products with the intermediate vector 240 generated for each feature vector of a feature vector set.

The projection engine 110 may thus generate output vectors with an output dimensionality that are random projections of feature vectors with an initial dimensionality. In doing so, the projection engine 110 may apply orthogonal transformations at an extended dimensionality orders of magnitude less than that output dimensionality, yet nonetheless compute the random projections with the output dimensionality. As such, the projection engine 110 may provide a computationally efficient process to compute random projections, even for vectors and hash universes of large dimensionality. The greater the configured output dimensionality of random projections, the greater the efficiency that may result from the output vector generation features described herein. The increased efficiency and reduced time-complexity may support real-time analysis, classification, and machine-learning for feature vector sets numbering in the millions or more, which may be particularly useful for applications with speed or resource-consumption constraints.

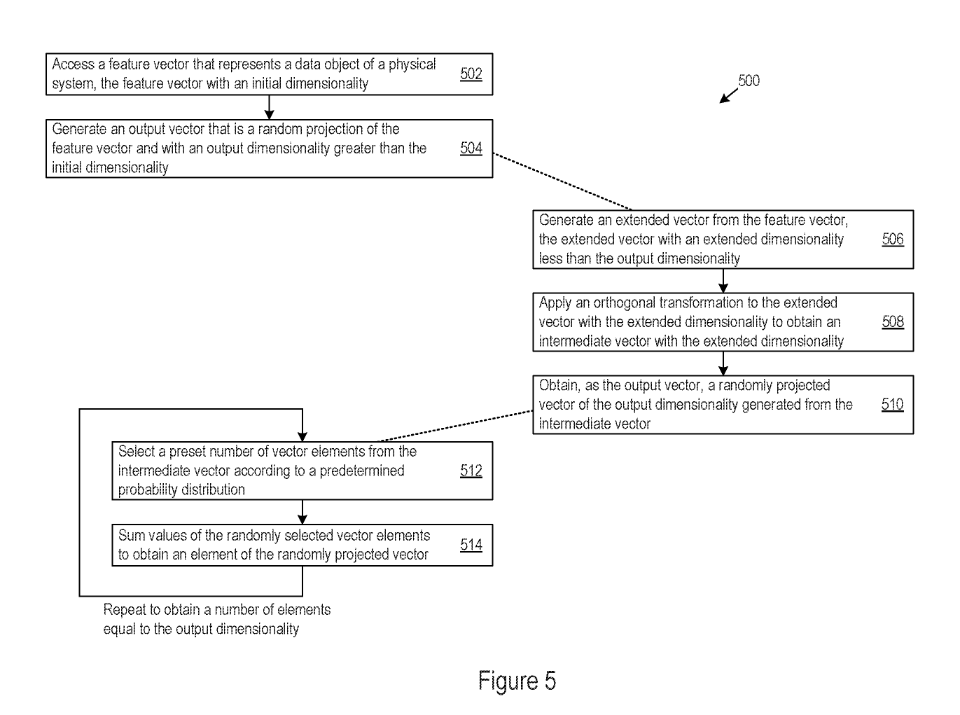

FIG. 5 shows a flow chart of an example method 500 for generation of output vectors from feature vectors representing data objects of a physical system. Execution of the method 500 is described with reference to the access engine 108 and the projection engine 110, though any other device, hardware-programming combination, or other suitable computing system may execute any of the steps of the method 500. As examples, the method 500 may be implemented in the form of executable instructions stored on a machine-readable storage medium or in the form of electronic circuitry.

In implementing or performing the method 500, the access engine 108 may access a feature vector that represents a data object of a physical system, the feature vector with an initial dimensionality (502). In some instances, the access engine 108 may receive feature vectors as a training set for a machine-learning application. The accessed feature vectors may number in the millions, the tens of millions or more, for example as a real-time data stream for anomaly detection.

In implementing or performing the method 500, the projection engine 110 may generate an output vector that is a random projection of the feature vector and with an output dimensionality greater than the initial dimensionality (504). Such a generation may include the projection engine 110 generating an extended vector from the feature vector, the extended vector with an extended dimensionality less than the output dimensionality (506). In some examples, the projection engine 110 may generate the extended vector by concatenating the feature vector together a calculated number of times, padding the concatenated feature vectors with vector elements having a ‘0’ value to obtain a pre-extended vector with the extended dimensionality, and randomly permuting the pre-extended vector to obtain the extended vector. The extended dimensionality may be user-configurable, for example through a user interface such as a command line interface, a parameter in a code section, a graphical user interface, etc.

To generate the output vector, the projection engine 110 may also apply an orthogonal transformation to the extended vector with the extended dimensionality to obtain the intermediate vector with the extended dimensionality (508). In some examples, the extended dimensionality may be orders of magnitude less than the output dimensionality. In that regard, the projection engine 110 may apply the orthogonal transformation on the intermediate vector with the extended dimensionality (a dimensionality of 4,096 as an illustrative example) instead of generating a random projection of the feature vector through orthogonal transformation applications at the output dimensionality (a dimensionality of 32,768 as an illustrative example). Put another way, the projection engine 110 may support generation of output vectors with the output dimensionality that are random projections of the feature vector, but do without having to perform orthogonal transformation computations at the output dimensionality. Doing so may increase computational efficiencies, reduce the time-complexity of random projection computations, and increase the speed at which such output vectors are generated, which may be particularly useful for machine-learning applications, classification technologies, and processing of real-time streaming data.

From the intermediate vector, the projection engine 110 may obtain, as the output vector, a randomly projected vector with the output dimensionality (510). To obtain the randomly projected vector with the output dimensionality, the projection engine 110 may select a preset number of vector elements from the extended vector according to a predetermined probability distribution (512), for example according to a uniform probability distribution. The preset number of vector elements that are selected according to the predetermined probability distribution may be user-configurable, e.g., via a graphic user interface. The projection engine 110 may also sum the values of the selected vector elements to obtain a vector element of the randomly projected vector (514). The projection engine 110 may repeat these selection and the summation steps for multiple iterations to obtain a number of vector elements (for the output vector) equal to the output dimensionality.

Accordingly, each iteration of the random selection and summation steps may generate a vector element of the randomly projected vector, and the projection engine 110 may perform a number of iterations equal to the output dimensionality to obtain such a number of elements. In that regard, the number of generated elements may be equal to the output dimensionality and together form the vector values of a randomly projected vector with the output dimensionality. Upon obtaining the randomly projected vector with the output dimensionality, the projection engine 110 may output the randomly projected vector with the output dimensionality as the output vector generated from the feature vector. For instance, the projection engine 110 or other computing logic may select a number of values from the output vector as CRO hash values.

In some examples, the projection engine 110 may select vector elements from the intermediate vector according to the predetermined probability distribution through a sparse binary vector set, e.g., in any of the ways discussed above. In that regard, the projection engine 110 may generate a sparse binary vector set as a number of sparse binary vectors equal to the output dimensionality. Each sparse binary vector in the sparse binary vector set may have a dimensionality equal to the extended dimensionality. Each sparse binary vector of the sparse binary vector set may also have a preset number of vector elements having a ‘1’ value, which may be equal to the preset number of vector elements selected from the intermediate vector according to the predetermined probability distribution as well as a remaining number of vector elements having a ‘0’ value. Through generation and application of the sparse binary vector set, the projection engine 110 may select and sum the vector elements of the intermediate vector to generate the output vector with the output dimensionality.

For instance, the projection engine 110 may select the preset number of vector elements from the intermediate vector according to the predetermined probably distribution through the vector indices of the vector elements having a ‘1’ value in a particular sparse binary vector. This may be the case as the projection engine 110 may generate the particular sparse binary vector through selecting the specific vector elements in the particular sparse binary vector having a ‘1’ value according to the predetermined probability distribution. For this particular sparse binary vector, the projection engine 110 may sum the values of the selected vector elements from the intermediate vector by computing the inner product of the intermediate vector and the particular sparse binary vector. As such, repeating the random selection and summing may include selecting the preset number of vector elements from the intermediate vector through the vector indices of the vector elements having a ‘1’ value in each other sparse binary vector in the sparse binary vector set and computing the inner product of the intermediate vector and each of the other sparse binary vectors of the sparse binary vector set.

As noted above, the projection engine 110 may also represent the sparse binary vector set as a matrix with a number of rows equal to the preset number of vector elements having a ‘1’ value for each sparse binary vector and a number of columns equal to the output dimensionality. In the matrix, a particular matrix column may represent a particular sparse binary vector and each matrix value of the particular matrix column may represent an index of a vector element in the particular sparse binary vector that has a ‘1’ value. The projection engine 110 may reference the matrix to increase the efficiency of inner product computations.

Although one example was shown in FIG. 5, the steps of the method 500 may be ordered in various ways. Likewise, the method 500 may include any number of additional or alternative steps, including steps implementing any feature described herein with respect to the access engine 108, projection engine 110, or combinations thereof.

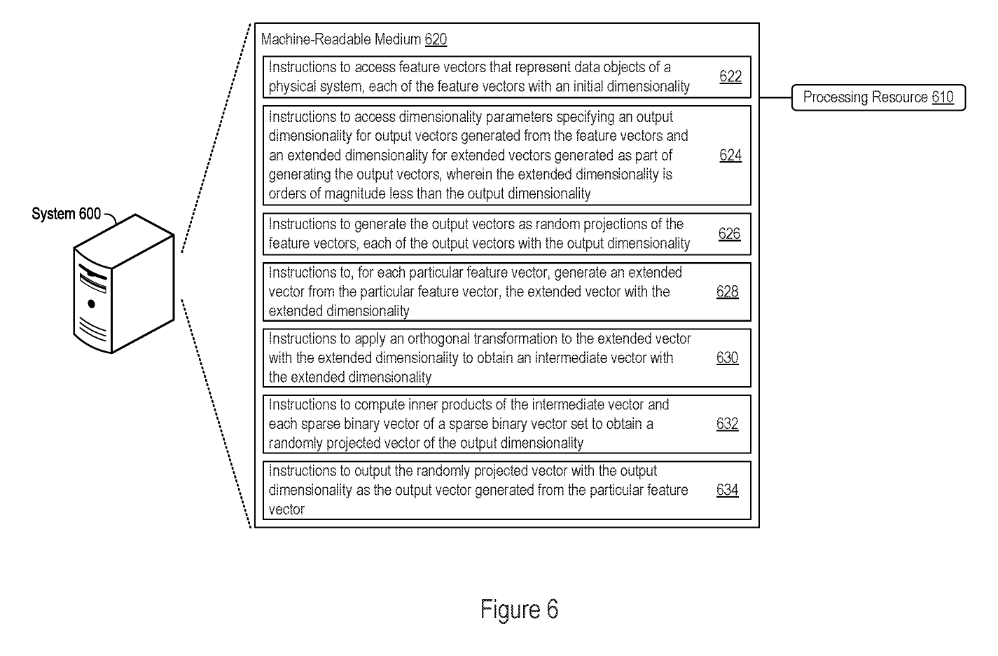

FIG. 6 shows an example of a system 600 that supports generation of output vectors from feature vectors representing data objects of a physical system. The system 600 may include a processing resource 610, which may take the form of a single or multiple processors. The processor(s) may include a central processing unit (CPU), microprocessor, or any hardware device suitable for executing instructions stored on a machine-readable medium, such as the machine-readable medium 620 shown in FIG. 6. The machine-readable medium 620 may be any non-transitory electronic, magnetic, optical, or other physical storage device that stores executable instructions, such as the instructions 622, 624, 626, 628, 630, 632 and 634 shown in FIG. 6. As such, the machine-readable medium 620 may be, for example, Random Access Memory (RAM) such as dynamic RAM (DRAM), flash memory, memristor memory, spin-transfer torque memory, an Electrically-Erasable Programmable Read-Only Memory (EEPROM), a storage drive, an optical disk, and the like.

The system 600 may execute instructions stored on the machine-readable medium 620 through the processing resource 610. Executing the instructions may cause the system 600 to perform any of the features described herein, including according to any features of the access engine 108, projection engine 110, or combinations thereof.

For example, execution of the instructions 622, 624, 626, 628, 630, 632, and 634 by the processing resource 610 access feature vectors that represent data objects of a physical system, each of the feature vectors with an initial dimensionality; access dimensionality parameters specifying an output dimensionality for output vectors generated from the feature vectors and an extended dimensionality for extended vectors generated as part of generating the output vectors, wherein the extended dimensionality is orders of magnitude less than the output dimensionality; and generate the output vectors as random projections of the feature vectors, each of the output vectors with the output dimensionality. Generation of the output vectors includes, for each particular feature vector, generating an extended vector from the particular feature vector, the extended vector with the extended dimensionality; applying an orthogonal transformation to the extended vector with the extended dimensionality to obtain an intermediate vector with the extended dimensionality; computing inner products of the intermediate vector and each sparse binary vector of a sparse binary vector set to obtain a randomly projected vector with the output dimensionality; and outputting the randomly projected vector with the output dimensionality as the output vector generated from the particular feature vector.

In some examples, the machine-readable medium 620 may further include instructions executable by the processing resource 610 to generate the sparse binary vector set as a number of sparse binary vectors equal to the output dimensionality, wherein each sparse binary vector in the sparse binary vector set has a dimensionality equal to the extended dimensionality and has a preset number of vector elements having a ‘1’ value and a remaining number of vector elements having a ‘0’ value. In such examples, the instructions may be executable by the processing resource 610 to generate the sparse binary vector set further by determining the vector elements having a ‘1’ value in the sparse binary vectors according to a predetermined probability distribution, such as a uniform distribution. The same sparse binary vector set to may be used to generate each of the output vectors from the feature vectors.

As another example, the machine-readable medium 620 may further include instructions executable by the processing resource 610 to represent the sparse binary vector set as a matrix with a number of rows equal to the preset number of vector elements having a ‘1’ value for each sparse binary vector and a number of columns equal to the output dimensionality. A particular matrix column in the matrix may represent a particular sparse binary vector and each matrix value of the particular matrix column may represent an index of a vector element in the particular sparse binary vector that has a ‘1’ value. The matrix may provide a space-efficient representation of the sparse binary vector set and increase computational efficiency for the inner product computations in random projection generation.

The systems, methods, devices, engines, and logic described above, including the access engine 108 and the projection engine 110, may be implemented in many different ways in many different combinations of hardware, logic, circuitry, and executable instructions stored on a machine-readable medium. For example, the access engine 108, the projection engine 110, or both, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the access engine 108, projection engine 110, or both.

The processing capability of the systems, devices, and engines described herein, including the access engine 108 and the projection engine 110, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A system comprising:
an access engine to access a feature vector that represents a data object of a physical system, the feature vector with an initial dimensionality; and
a projection engine to:
generate an extended vector from the feature vector, the extended vector with an extended dimensionality;
apply an orthogonal transformation to the extended vector to obtain an intermediate vector with the extended dimensionality;
compute inner products of the intermediate vector and each sparse binary vector of a sparse binary vector set to obtain a randomly projected vector with an output dimensionality, wherein the output dimensionality is greater than the extended dimensionality of the intermediate vector; and
output the randomly projected vector as an output vector generated from the feature vector that is a random projection of the feature vector with the output dimensionality.

2. The system of claim 1, wherein the output dimensionality is orders of magnitude greater than the extended dimensionality.

3. The system of claim 1, wherein the projection engine is to generate the extended vector by:
concatenating the feature vector together a calculated number of times;
padding the concatenated feature vectors with vector elements having a ‘0’ value to obtain a pre-extended vector with the extended dimensionality; and
randomly permuting the pre-extended vector to obtain the extended vector.

4. The system of claim 1, wherein projection engine is to set the extended dimensionality or the output dimensionality according to a user input received through a user interface.

5. The system of claim 1, wherein the projection engine is further to generate the sparse binary vector set as a number of sparse binary vectors equal to the output dimensionality; and
wherein each sparse binary vector in the sparse binary vector set has a dimensionality equal to the extended dimensionality and has a preset number of vector elements having a ‘1’ value and a remaining number of vector elements having a ‘0’ value.

6. The system of claim 5, wherein the projection engine is further to generate the sparse binary vector set by determining the vector elements having a ‘1’ value in the sparse binary vectors according to a predetermined probability distribution.

7. The system of claim 5, wherein the projection engine is further to represent the sparse binary vector set as a matrix with a number of rows equal to the preset number of vector elements having a ‘1’ value for each sparse binary vector and a number of columns equal to the output dimensionality; and
wherein a particular matrix column in the matrix represents a particular sparse binary vector and each matrix value of the particular matrix column represents an index of a vector element in the particular sparse binary vector that has a ‘1’ value.

8. A method comprising:
accessing a feature vector that represents a data object of a physical system, the feature vector with an initial dimensionality; and
generating an output vector that is a random projection of the feature vector and with an output dimensionality greater than the initial dimensionality, wherein generating comprises:
generating an extended vector from the feature vector, the extended vector with an extended dimensionality less than the output dimensionality;
applying an orthogonal transformation to the extended vector to obtain the intermediate vector with the extended dimensionality;
obtaining, as the output vector, a randomly projected vector with the output dimensionality generated from the intermediate vector by:
selecting a preset number of vector elements from the intermediate vector according to a predetermined probability distribution;
summing values of the selected vector elements to obtain a vector element of the randomly projected vector; and
repeating the selecting and the summing to obtain a number of vector elements equal to the output dimensionality.

9. The method of claim 8, wherein generating the extended vector from the feature vector comprises:
concatenating the feature vector together a calculated number of times;
padding the concatenated feature vectors with vector elements having a ‘0’ value to obtain a pre-extended vector with the extended dimensionality; and
randomly permuting the pre-extended vector to obtain the extended vector.

10. The method of claim 8, further comprising generating a sparse binary vector set as a number of sparse binary vectors equal to the output dimensionality;
wherein each sparse binary vector in the sparse binary vector set has a dimensionality equal to the extended dimensionality and is generated to include a preset number of vector elements having a ‘1’ value equal to the preset number of vector elements selected from the intermediate vector and a remaining number of vector elements having a ‘0’ value, the preset number of vector elements having a ‘1’ value determined according to the predetermined probability distribution;
comprising selecting the preset number of vector elements from the intermediate vector through the vector indices of the vector elements having a ‘1’ value in a particular sparse binary vector; and
comprising summing values of the selected vector elements through computing an inner product of the intermediate vector and the particular sparse binary vector.

11. The method of claim 10, wherein repeating the selecting and the summing comprises:
selecting the preset number of vector elements from the intermediate vector through the vector indices of the vector elements having a ‘1’ value in each other sparse binary vector in the sparse binary vector set; and
computing the inner product of the intermediate vector and each of the other sparse binary vectors of the sparse binary vector set.

12. The method of claim 10, further comprising representing the sparse binary vector set as a matrix with a number of rows equal to the preset number of vector elements having a ‘1’ value for each sparse binary vector and a number of columns equal to the output dimensionality; and
wherein a particular matrix column in the matrix represents a particular sparse binary vector and each matrix value of the particular matrix column represents an index of a vector element in the particular sparse binary vector that has a ‘1’ value.

13. The method of claim 10, further comprising using the sparse binary vector set in generating output vectors for other feature vectors representing other data objects of the physical system.

14. The method of claim 8, wherein the output dimensionality, the extended dimensionality, or the preset number of vector elements selected from the intermediate vector is user configurable through a user interface.

15. The method of claim 8, wherein the extended dimensionality is orders of magnitude less than the output dimensionality.

16. A non-transitory machine-readable medium comprising instructions executable by a processing resource to:
access feature vectors that represent data objects of a physical system, each of the feature vectors with an initial dimensionality;
access dimensionality parameters specifying an output dimensionality for output vectors generated from the feature vectors and an extended dimensionality for extended vectors generated as part of generating the output vectors, wherein the extended dimensionality is orders of magnitude less than the output dimensionality; and
generate the output vectors as random projections of the feature vectors, each of the output vectors with the output dimensionality, and wherein generation of the output vectors includes, for each particular feature vector:
generating an extended vector from the particular feature vector, the extended vector with the extended dimensionality;
applying an orthogonal transformation to the extended vector with the extended dimensionality to obtain an intermediate vector with the extended dimensionality;
computing inner products of the intermediate vector and each sparse binary vector of a sparse binary vector set to obtain a randomly projected vector with the output dimensionality; and
outputting the randomly projected vector with the output dimensionality as the output vector generated from the particular feature vector.

17. The non-transitory machine-readable medium of claim 16, further comprising instructions executable by the processing resource to:
generate the sparse binary vector set as a number of sparse binary vectors equal to the output dimensionality, wherein each sparse binary vector in the sparse binary vector set has a dimensionality equal to the extended dimensionality and has a preset number of vector elements having a ‘1’ value and a remaining number of vector elements having a ‘0’ value.

18. The non-transitory machine-readable medium of claim 17, wherein the instructions are executable by the processing resource to generate the sparse binary vector set further by determining the vector elements having a ‘1’ value in the sparse binary vectors according to a predetermined probability distribution.

19. The non-transitory machine-readable medium of claim 17, further comprising instructions executable by the processing resource to:
represent the sparse binary vector set as a matrix with a number of rows equal to the preset number of vector elements having a ‘1’ value for each sparse binary vector and a number of columns equal to the output dimensionality; and
wherein a particular matrix column in the matrix represents a particular sparse binary vector and each matrix value of the particular matrix column represents an index of a vector element in the particular sparse binary vector that has a ‘1’ value.

20. The non-transitory machine-readable medium of claim 16, wherein the instructions are executable by the processing resource to use the same sparse binary vector set to generate each of the output vectors from the feature vectors.
